(19) United States
(12) Patent Application Publication
(10) Pub. No.: US 2023/0329254 A1
(43) Pub. Date: Oct. 19, 2023

(54) POULTRY PROCESSING SYSTEM AND METHOD

(71) Applicant: Spraying Systems Co., Wheaton, IL (US)

(72) Inventors: Michael D. McIntyre, Covington, LA (US); Douglas E. Cosby, Arnoldsville, GA (US); Aaron Jordan, Gilberts, IL (US)

(21) Appl. No.: 18/133,633

(22) Filed: Apr. 12, 2023

Related U.S. Application Data
(60) Provisional application No. 63/330,565, filed on Apr. 13, 2022.

(51) Int. Cl. A22C 21/04; A22C 21/00

(52) U.S. Cl. CPC A22C 21/0061; A22C 21/0007; A22C 21/0053; A22C 21/04

(57) ABSTRACT

A poultry processing system having a cleaning station, a scalding station, a picker station and a transfer line for supporting a poultry carcass head down through the processing stations. The cleaning station including a plurality of spray manifolds coupled to a cleaning liquid supply each having a plurality of spaced apart spray nozzles for directing cleaning liquid onto the carcasses from the tail to head as they are transferred through the cleaning station for removing dirt, fecal material, and other foreign matter from the carcasses prior to transfer to the scalding and picker stations.

### CROSS-REFERENCE TO RELATED APPLICATION

This patent application claims the benefit of U.S. Provisional Pat. Application No. 63/330,565, filed Apr. 13, 2022, which is incorporated by reference.

### FIELD OF THE INVENTION

The present invention relates to systems for commercially processing poultry, such as chickens and other feathered birds, and more particularly, to an apparatus and method for more effectively cleaning the poultry during the course of such processing.

### BACKGROUND OF THE INVENTION

Commercially processed raw poultry is a major source of foodborne illness in the USA and across the globe. In commercial processing facilities, the feathered birds typically enter the facility in highly soiled conditions. Tests have revealed Total Aerobic Counts (TAC) on the birds of over a billion colonies, capable of causing extreme illnesses.

In processing, the bird carcasses are exsanguinated (bled to death), scalded in scalding tanks (dipped in heated water of [123-135° F.] to loosen feathers), and picked (feathers removed by mechanical methods). This all takes place on the “Kill Floor”.

Before the feathers are removed, the carcasses enter communal scalders in which scalding water becomes a high source of pathogens, as such as Salmonella and Campylobacter. The water is extremely hot and becomes contaminated within minutes as it continually collects dirt, such as soil, and fecal material from the processed birds throughout the operating shift. Over 100 birds per minute hanging on a shackle line carrying bacteria and pathogens are processed through the common scalders that may not be drained until the end of the day. At that point, fecal matter and accumulating dirt in the tubs also can be difficult to clean. With much of the soil and fecal material on the birds forced into the scalding tanks during processing, in the trade the scalding water commonly has been referred to as “fecal soup”, which further exposes each carcass processed through the scalder to contamination. Moreover, once the feathers are removed, the contaminants can enter the feather follicles and other tissues. At that point, it is difficult for sanitizers to reach the entranced pathogens.

While bird washing systems utilizing revolving brushes have attempted in the past to clean the feathered carcasses before entering the scalders, most have been abandoned. The spinning brushes are easily contaminated, can damage the skin, are difficult to sanitize, and can drive dirt and pathogens into the skin and tissues of the birds.

### OBJECTS OF THE INVENTION

An object of the present invention is to provide a poultry processing system operable for more efficiently and safely processing poultry for human consumption.

Another object is to provide a poultry processing system as characterized above which minimizes the accumulation of contaminants in scalding tanks.

A further object is to provide a poultry processing system of the above kind that utilizes a brushless system in more effectively cleaning the poultry prior to entering the scalding tanks.

Still, another object is to provide a poultry processing system of the foregoing type that minimizes the necessity and cost of frequent replenishing of water in the scalding tank.

Another object is to provide such a poultry processing system that effectively reduces fecal contamination and bacteria load throughout the processing plant, plus reducing the amount of water needed to wash picked carcasses and subsequent processing stations.

Still a further object is to provide such a poultry cleaning system that is relatively simple in design and economical in manufacture and usage.

Other objects and advantages of the invention will become apparent upon reading the following detailed description and upon reference to the drawings. The identified objects are not intended to limit the present invention.

### BRIEF DESCRIPTION OF THE DRAWINGS

FIG. 1 is a prospective of an illustrative poultry processing system having a poultry cleaning station in accordance with the invention;

FIG. 2 is an end view of the illustrated cleaning station;

FIG. 3 a side perspective of the cleaning station;

FIG. 4 is a side perspective of the cleaning station similar to FIG. 3, but with a housing structure on one side removed for better depicting poultry transfer through the cleaning system;

FIG. 5 is a side view of the cleaning station shown in FIG. 4, with both the housing structure and spray manifold arrangement on one side removed;

FIG. 6 is a perspective of the cleaning station with housing structures on both sides removed for better depicting the spray manifold arrangements and respective liquid supplies;

FIG. 7 is an enlarged perspective of the liquid supply of one of the spray manifold arrangements shown in FIG. 6;

FIG. 8 is a further perspective depicting the liquid supply to one of the spray manifold arrangements;

FIG. 9 is a perspective depicting the mounting of the spray manifolds on one of the vertical supports of the illustrative cleaning station;

FIG. 10 is a section showing the mounting of the spray nozzle on one of the spray manifolds; and

FIGS. 11A and 11B are enlarged sections of one of the illustrated spray nozzles showing its oscillating liquid discharge.

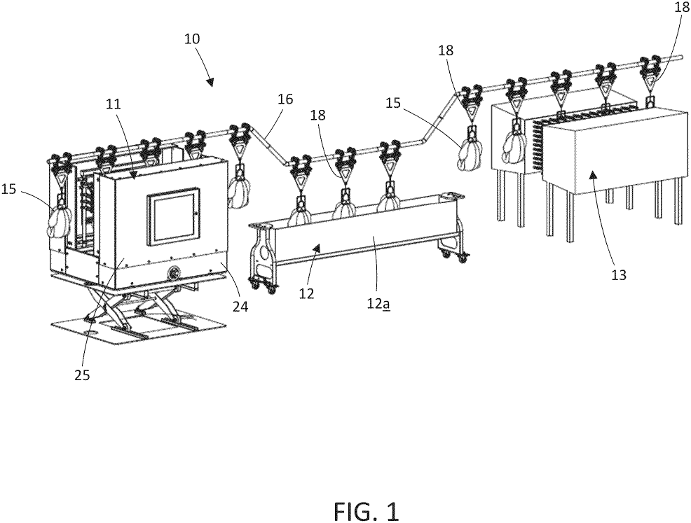

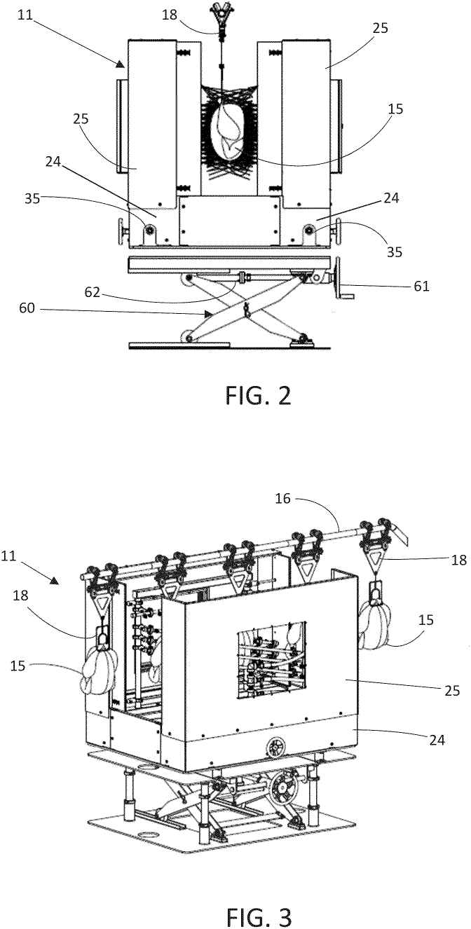

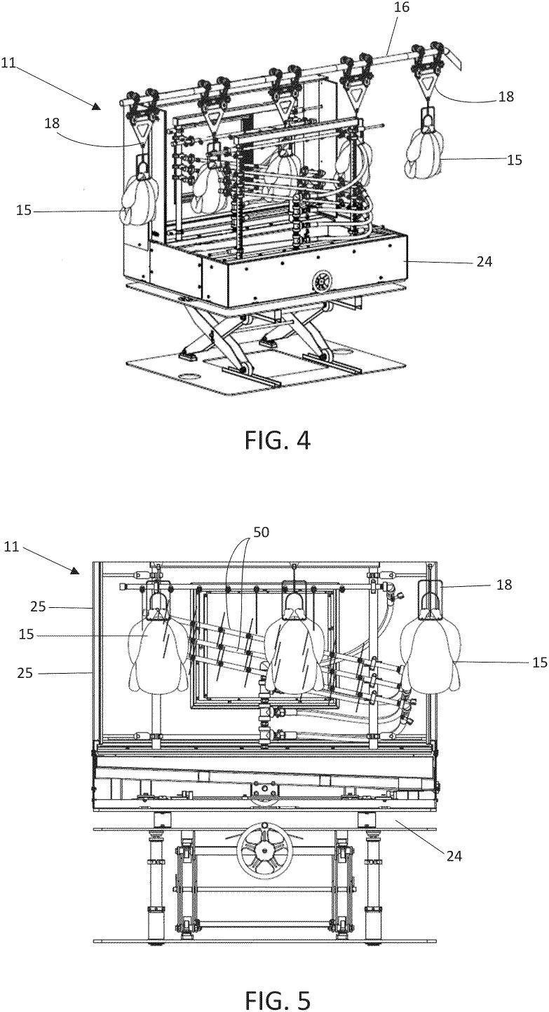

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF PREFERRED EMBODIMENT

Referring now more particularly to the drawings, there is shown an illustrative poultry processing system 10 in accordance with the invention. The illustrated system 10 comprises a cleaning station 11, a scalding station 12, and a picker station 13. It will be understood that prior to the cleaning station 11, the poultry would be processed through an exsanguinating station where they are de-bled and subsequent to the picker station 13 to an eviscerating station for removing entrails prior to final processing.

Bird carcasses 15 are processed through the processing stations 11, 12, 13 by a conventional conveyer having a moveable transfer line 16 with spaced apart shackles 18 from which the bird carcasses 15 are suspended head down. The scalding and picker stations 12, 13 may be of known types. As indicated, the scalding station 12 includes a tank 12a containing scalding water into which the birds 15 are lowered by the transfer line 16 and the scalded birds are then transferred upwardly and through the picker station 13 where feathers are removed in preparation for subsequent processing.

In accordance with the present invention, the cleaning station includes a plurality of liquid spray nozzles disposed on opposite sides of the line of movement of bird carcasses through the cleaning station for forcefully spraying water and/or other cleaning liquids onto the birds from a top to bottom direction for effectively cleaning the birds of dirt, fecal material, and other foreign matter prior to direction to the scalding station. To that end, the cleaning station includes liquid spray manifold arrangements on opposite sides of the line of passage of birds through the cleaning station, each having a plurality of specifically arranged liquid spray nozzles. In the illustrated embodiment, each spray manifold arrangement includes an upper horizontal spray manifold 20 disposed in slightly elevated relation to the passing birds having a plurality of liquid spray nozzles 21 longitudinally spaced in the direction of bird movement through the cleaning station 11. Each spray nozzle 21 in this case is supported on a mounting stem 23 extending transversely and in fluid communication with the spray manifold 20 and is secured to the mounting stem 23 by a retention cap 21a in a conventional manner (FIG. 10). Each upper horizontal spray module 20 is supported between a pair of upstanding vertical supports 22 extending upwardly from a respective side of a housing base 24. Housing structures 25 are supported in upstanding relation to the base 24 on opposite outer sides of the spray manifolds 20 for containing liquid within the housing structures 25 during operation.

Each upper spray manifold 20 is supported between the upstanding vertical supports 22 by an adjustable clamp and collar assembly 28, as best depicted in FIG. 9. Each clamp and collar assembly 28 includes a clamp 29 releasably secured about the vertical support structure 22, which is preferably cylindrical in form, and carries a laterally extending arm 29a, for rotatably receiving a transverse mounting stud 30a of a collar 30 secured about an end section of the horizontal spray manifold 20. The collar 30 is rotatably positionable with respect to the arm 29a and can be secured in place by a threaded bolt 29b.

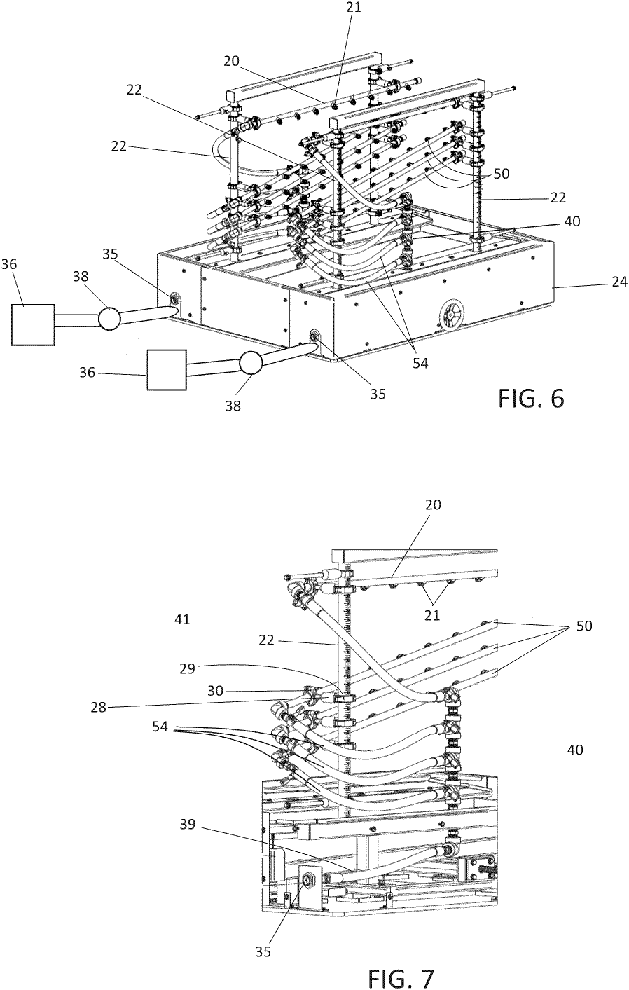

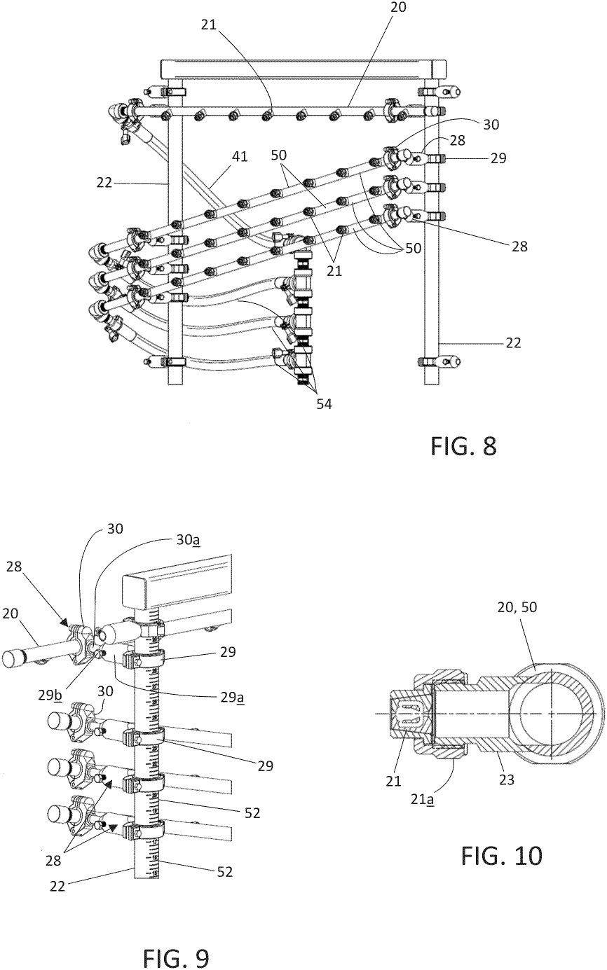

High pressure liquid or other cleaning fluid may be supplied to the spray manifolds 20 from a respective liquid inlet 35 in the base 24 coupled to a liquid supply 36 and under the direction of a high pressure pump 38 (FIG. 6). For each spray manifold 20, the respective liquid inlet port 35 communicates through an inlet hose 39 to a distribution manifold 40 and then through a supply hose 41 coupled between the distribution manifold 40 and an inlet end of the upper spray manifold 20 (FIG. 7).

The upper spray manifolds 20 in this case each are supported slightly above the bird carcasses 25 passing through the cleaning station 11 and with the spray nozzles 21 angled downwardly for directing high pressure liquid onto the vent/tail area of the passing birds, traditionally the dirtiest part of the feathered carcasses. The vent/tail area often is caked with soil and fecal material and is a major source of bacteria. The spray nozzles 21 of the upper spray manifolds 20 in this case specifically target the vent/tail area for initial cleaning. The cleaning water, preferably pre-heated to temperatures of 130° F. and directed at pressures up to 650 psi, effectively engages, dislodges, and removes the soil, fecal, and other foreign matter from the vent area of bird carcasses and pre-moistens and loosens the feathers, prior to direction to the scalding station 12 for enabling more effective, germ free scalding of the carcasses.

In carrying out a further feature of the present embodiment, a plurality of further spray manifolds 50, in this case three in number, are disposed below the upper manifolds 20 on each side of the cleaning station and for supporting a plurality of spray nozzles 21 in progressively lower relation to the passing bird carcasses 15 in the direction of movement. Each of these further spray manifolds 50 are mounted directly under the respective upper spray manifold 20 and the high pressure liquid spray discharges are effective in driving fecal material and soil downwardly from the vent/tail area towards the head and off the carcass 15. Such progressive downward spraying continues as the carcasses 15 progress rapidly toward the scalding tank 12a.

Each of the lower spray manifolds 50 in this case are angled downwardly in the direction of bird movement through the cleaning station 11 with the spray nozzles 21 of each of the angled spray manifold 50 in vertically aligned relation. The vertically aligned nozzles 21 of the angled spray manifolds 50 direct high pressure liquid spray onto the passing bird carcasses at progressively lower levels as the birds pass through the cleaning station 11. The lower angled spray manifolds 50, similar to the upper spray manifolds 20, are mounted between the vertical supports 22 by similar clamp and collar assemblies 28 which enable selected angular positioning of the spray manifolds 50 between the vertical supports 22.

Height adjustment graduations 52 (FIG. 9) on the vertical supports 22 allow similar settings to be achieved on opposite sides of the travelling bird carcasses 15 and repeatability from setup to setup. The angled spray manifolds 50 each receive pressurized liquid from the respective liquid inlet 35 and cleaning fluid distribution manifold 40, by respective cleaning fluid supply hoses 54 coupled between the cleaning fluid distribution manifold 40 and the end of each respective angled spray manifold 50. Hence, as can be seen, as the bird carcasses 15 are transferred through the cleaning station 11, the groups of vertically aligned spray nozzles 21 of the angled spray manifolds 50 progressively further direct cleaning fluid from a top to bottom fashion. It will be understood that while the lower spray manifolds 50 in this case are angled to the horizontal, alternatively they could be horizontally disposed with spray nozzles 21 mounted thereon in similar descending relation as the angled spray manifolds 50.

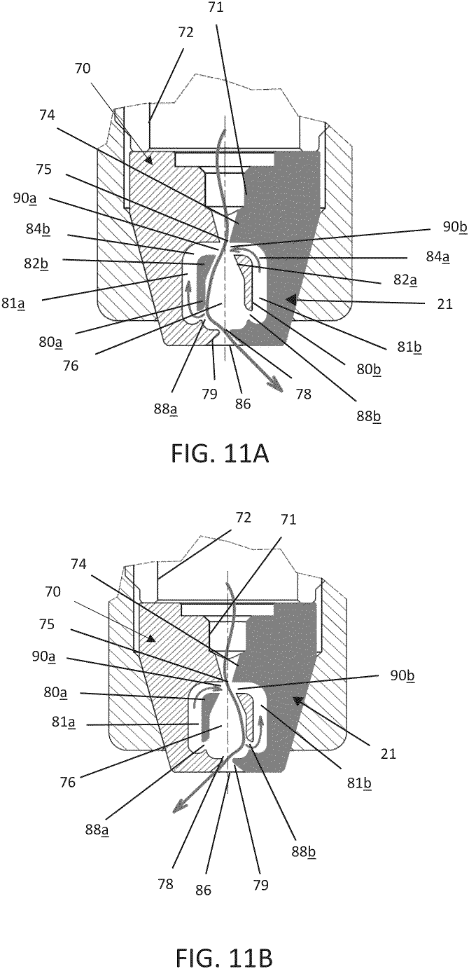

In keeping with the further feature of this embodiment, the spray nozzles 21 each are fluidic spray nozzle assemblies for a discharging high pressure, vertically oriented oscillating liquid spray discharges for more effectively dislodging foreign matter from the feathered carcasses and driving such materials downwardly off of the bird carcasses. The fluidic spray nozzles may be of a type disclosed in U.S. Pat. 10,875,035, assigned to Spraying Systems Company, coassignee of the subject application, the disclosure of which is incorporated by reference. The illustrated spray nozzles 21, as last depicted in FIGS. 10, 11A, and 11B, have a nozzle body 70 with a liquid inlet passage 71 that communicates with an upstream passage 72 in the nozzle support stem 23 and a respective spray manifold 20, 50. The nozzle inlet passage 71 converges by way of an inwardly converging conical section 74 that defines a liquid inlet orifice 75. The liquid inlet orifice 75 communicates with a downstream expansion chamber 76, which in turn communicates with an axially aligned exit orifice 78 that communicates with an outwardly flared section 79 having a vertically oriented elongated narrow rectangular configuration.

In order to produce a fluidic oscillating liquid discharge, the nozzle body 70 has a pair of longitudinal veins or ribs 80a, 80b which define the central expansion chamber 76 and a pair of outwardly disposed feedback passages 81a, 81b. The veins 80a, 80b in this case each have an enlarged upstream end portion 82a, 82b that defines a curved right angle passage section 84a, 84b of each feedback passage 81a, 81b in communication with the inlet orifice 75. When liquid is directed through the nozzle body inlet orifice 75, and is guided downwardly against the lower vein 80a, it is redirected upwardly through the exit and discharge orifices 78, 86, creating a high pressure at a downstream feedback orifice 88a. That high pressure condition is communicated through the feedback passage 81a to an upstream orifice 90a, forcing liquid discharging from the inlet orifice 75 upwardly against the upper vein 80b, as viewed in FIG. 11B, and in turn, downwardly through the exit discharge orifices 78, 86. This redirection of liquid creates a high pressure in the downstream feedback orifice 88b, which communicates with an upstream orifice 90b again forcing liquid discharging form the inlet orifice 75 in a downward direction against the lower vein 80b, as depicted in 11A. The liquid flow stream through the nozzle body 70 creates repeatable oscillation cycle, causing the exiting spray to forcefully oscillate vertically from the discharge orifices 78, 86, penetrating the feathers of the passing carcasses and directing the liquid downwardly from the carcass for effective cleaning of the carcasses prior to entering the scalding tank 12a.

From the foregoing, it can be seen that the brushless high water pressure cleaning system of the subject invention washes feathered poultry carcasses with clean heated water before they enter the scalding tank. The heated water kills much of the bacteria, and the oscillating high pressure spray patterns are aligned to progressively wash the feathered carcasses from top to bottom as they travel down the shackle line. This motion pushes the soil and fecal material down and off the carcasses before they enter the scalders. Each carcass is washed using fresh clean water, and by effectively scrubbing the feathered carcasses without brushes, the water is always clean and there is no apparatus to cut and/or scar the skin and tissues of the carcasses. In a commercial operation, the system reduces the amount of soil and fecal material entering the scalding tanks and downstream processing stations, the amount of clean water needed to replenish the scalding tanks and clean the downstream processing stations, and the bacterial loads and cross contamination that can become trapped in the feather follicles of processed carcasses.

What is claimed:

1. A poultry processing system comprising;
a cleaning station, a scalding station, and a picker station;
a transfer line having a plurality of shackles each for supporting a poultry carcass head down with its tail facing upwardly for transfer through the cleaning station where the carcasses are cleaned with a cleaning liquid, the scalding station where the carcasses are successively positioned into a tank of scalding water, and the picker station in which feathers are removed in preparation for further processing of the carcasses;
said cleaning station including a spray manifold coupled to a cleaning liquid supply and having a plurality of spaced apart spray nozzles for directing cleaning liquid onto the carcasses transferred through the cleaning station for removing dirt, fecal material, and other foreign matter from the carcasses as they are transferred through the cleaning station prior to transfer to the scalding station and immersion into the scalding tank.

2. The poultry processing system of claim 1 including a plurality of said spray manifolds in which at least one of the spray manifolds being disposed above the carcasses being transferred through the cleaning station for directing cleaning liquid onto the tails of the passing carcasses.

3. The poultry processing system of claim 1 including a plurality of said spray manifolds in which at least one of said spray manifolds is disposed horizontally above the level of carcasses being transferred through said cleaning station with the spray nozzles thereof oriented downwardly for directing cleaning liquid downwardly onto the tails of the carcasses as they are transferred through the cleaning station, and other of said spray manifolds are dispersed below said horizontally disposed spray manifold.

4. The poultry processing system of claim 1 including a plurality of said spray manifolds support spray nozzles at descending levels along a path of transfer of carcasses through said cleaning station for successively directing cleaning fluid onto the carcasses from tail to head as the carcasses are transferred through the cleaning station.

5. The poultry processing system of claim 1 including a plurality of said spray manifolds, and the spray nozzles of said plurality of spray manifolds are disposed of in plurality of vertically aligned rows with each vertically aligned row being disposed at a lower level than the preceding vertically aligned row along the path of transfer of carcasses through the cleaning station.

6. The poultry processing system of claim 4 in which at least some of said spray manifolds are disposed at an angle to the path of transfer of carcasses through the cleaning station each for supporting a plurality of spray nozzles in descending relation to the path of transfer of carcasses transferred through the cleaning station.

7. The poultry processing system of claim 6 in which said manifolds dispensed at an angle to the path of transfer of the carcasses support the spray nozzles in vertically aligned arrays.

8. The poultry processing system of claim 7 in which each said array of vertically aligned spray nozzles is disposed lower than the proceeding array in a downstream direction of the path of transfer of carcasses through the cleaning station.

9. The poultry processing system of claim 5 in which said plurality of spray manifolds are connected to a common supply of cleaning liquid that is pre-heated to a temperature of 130 degrees and directed at pressures up to 650 PSI.

10. The poultry processing system of claim 1 in which the spray nozzles of said spray manifold are operable for spraying vertically oriented oscillating spray discharges on to the carcasses transferred through the cleaning station.

11. The poultry processing system of claim 1 in which said cleaning station includes a first array of said spray manifolds on one lateral side of a path of transfer of carcasses through said cleaning station and a second array of said spray manifolds on opposite lateral sides of the path of transfer.

12. The poultry processing system of claim 1 in which said cleaning station includes a cabinet having side units disposed on opposite lateral sides of the path of transfer of carcasses through the cleaning station for containing the spray of cleaning liquid within the cleaning station.

13. A method of processing poultry comprising the steps of transferring poultry carcasses through a cleaning station, a scalding station, and a picker station with the carcasses head down and tail facing upwardly, cleaning the carcasses passing through the cleaning station by forcefully spraying cleaning liquid on to tails of the carcasses for removing dirt, fecal material and other foreign matter from the carcasses as they pass through the cleaning station, and following passage of the carcasses through the cleaning station scalding the carcasses by positioning the carcasses into a tank of scalding water in the scalding station and following scalding of the carcasses transferring the carcasses to the picker station for removal of feathers from the carcasses.

14. The method of claim 13 including spraying cleaning liquid downwardly onto the tails of the carcasses passing through the cleaning station for driving cleaning liquid downwardly along the carcasses from tail to head.

15. The method of claim 13 including spraying cleaning liquid onto carcasses passing through the cleaning station at progressively lower levels onto the passing carcasses in relation to a path of transfer of the carcasses through the cleaning station.

16. The method of claim 13 including forcefully spraying a vertically aligned oscillating spray discharge of cleaning liquid onto the carcasses as they are transferred through the cleaning station.

17. The method of claim 13 including forcefully spraying a vertically aligned oscillating spray discharge of cleaning liquid onto the carcasses as they are transferred through the cleaning station.

18. The method of claim 17 including spraying said vertically discharged arrays of cleaning liquid onto carcasses passing through the cleaning station at progressively lower levels onto the passing carcasses in relation to a path of transfer of the carcasses through the cleaning station.
